(19) United States
(12) Patent Application Publication
(10) Pub. No.: US 2010/0169552 A1
(43) Pub. Date: Jul. 1, 2010

(54) REMOVALBLE MULTIMEDIA MEMORY CARD AND METHOD OF USE

(76) Inventor: Jaromir (Jarek) Krzysztof WASZCZYSZYN, Krakow (PL)

Correspondence Address: Sawyer Law Group, P.C., P.O. Box 51418, Palo Alto, CA, 94303, US

(21) Appl. No.: 12/565,701

(22) Filed: Sep. 23, 2009

Related U.S. Application Data
(60) Provisional application No. 61/141,624, filed on Dec. 30, 2008.

(51) Int. Cl. G06F 12/00; G06F 15/16

(52) U.S. Cl. 711/103; 711/115; 709/219; 711/E12.001; 711/E12.008

(57) ABSTRACT

A method and system is disclosed for distributing multimedia information. The system and method comprises sending a plurality of multimedia files to at least one server; and recording the plurality of multimedia files on a removable memory device. The removable memory device has a format that includes a predetermined information set that is described and physically stored thereon. The method and system is a complete solution for the commercial multimedia (audio, video, picture, text) distribution. Also, the method and system can be used for commercial distribution of any kind digital data (programs, bank data, documents, control etc). The method and system uses individual unique keycode for customized access to internet and any other electronic devices. All multimedia data files are stored on a removable memory device as a physical, hardware device.

### CROSS-REFERENCE TO RELATED APPLICATIONS

This application claims the benefit of U.S. Provisional Application No. 61/141,624, filed Dec. 30, 2008, Attorney Docket No. 4825PR, entitled, “AUDIO FLASH MEMORY CARD”; all of which are incorporated herein by reference in their entireties.

This application is related to U.S. Provisional Application No. 61/169,687, filed Apr. 15, 2009, Attorney Docket No. 4531PR, entitled, “SECURE DIGITAL MUSIC ALBUM FORMAT”; and co-pending U.S. patent application Ser. No. ______ (To Be Assigned), Attorney Docket No. 4531P, entitled “SECURE DIGITAL MUSIC ALBUM FORMAT,” filed on even date herein, which is incorporated by reference in its entirety.

### FIELD OF THE INVENTION

The present invention relates generally to audio and multimedia systems, possible activities utilizing personal unique keycode and more particularly to using a memory card for providing high quality non-compressed audio and multimedia data (video, pictures, text) or any other digital files in a variety of environments.

### BACKGROUND

Solid-state memories have been utilized for many years in portable MP3 players. In some players, for example, modern multi-function cellular phones, it is possible to prepare removable memory cards that include different music on each card. Then, by taking out one card and inserting another, the music can be changed. But these solutions all use low-quality devices, such as compressed audio data in MP3 format, and other similar processes.

Compact Disc's were a revolution in audio, not due to high sound quality (sound quality of the first CD players was relatively poor) but rather due to their ease of operation, and their portable use compared to vinyl long playing records (LPs) or a compact cassette. FIG. 1 illustrates the use of CDs at the present time, as the most popular way of commercial distribution of music and software 10. As is seen, music is performed and recorded 12. Thereafter the audio files created by recording the music are edited and mastered 14. Then the audio files are recorded on a glass matrix 16. This recorded glass matrix is utilized for the distribution of compact disk record as the physical medium for carrying prerecorded copies of digital audio data 18a-18n. For example, CDs 18a-18n can then be used for a home Hi-Fi system 22a, a portable audio system 22b, a personal audio device 22c, a car device system 22d and a computer 22e.

A CD or DVD (video) operates in a simple and almost identical fashion in all existing devices. There is no need for the operator to learn about their operation for each device they are utilized. Also, due to strict standards these same CD or DVD is able to play on any compatible device.

The CD standard is very well designed (it has been existence since at least 1982). However, it has limitations due to size, capacity and the needs of precision mechanics/optics. Also, another limitation is that it is very easy to make pirate (illegal) copies from a CD.

The CD/DVD standard is also very popular way for software commercial distribution.

Super Audio Compact Disc (SACD), DVD Audio (DVD-A) or Blue Ray disks were introduced that provided for higher sound quality than conventional CDs. Also, due to better copy protection these solutions were treated as follower of Compact Disc. However, these types of disks have not been highly successful commercially as audio data commercial distribution ways.

### Digital Multimedia Data Issues

There are different ways which provide multimedia. Some of those solutions provide a low quality sound and others provide a high quality sound. Some of the issues with utilizing these solutions in providing audio will be described below.

### Solutions for Lower Sound Quality

Examples of formats utilized for relatively low quality sound are MetaFrame Presentation Server 3 (MP3), and Advanced Audio Coding (AAC). MP3, AAC and other formats are utilized for lower sound quality while using lossy compression. Devices that utilize these formats typically need less than 10% of memory (as compared with original data). Devices that utilize these formats include portable devices such as the iPod®, car audio, home audio and software (songs, tunes).

A growing group of these players can read data from Flash memory cards. However, for the most part, the data is read as compressed, low quality MP3 format.

Therefore, there exists a large range of products ready for music stored in removable memory cards, but these products are typically utilized only for low quality MP3 players.

In most portable applications, Removable Memory Card is rater treated as expanding of existed device memory. Due to many different data formats exchange of the recorded cards can be difficult.

### Solutions for High Sound Quality

Typically, high quality formats are utilized when downloading to and from music servers. These formats exist as hardware (final user stationary music servers) and software (files with music to download). An example of a high sound quality format is Free Lossless Audio Codec (FLAC) (http://flac.sourceforge.net/). The FLAC format is compressed, but lossless, meaning that audio is compressed in FLAC without any loss in quality. FLAC files need 50% of the memory (as compared with original data), and the files can also include cover pictures, and some basic information about musicians. The format is license free.

However, a high quality format such as the FLAC format has several problems. For example, there is a problem with piracy due to the ease of copying of the music files. In addition, there is a complete disorder/disintegration in downloading data with different formats. There are many non-compatible formats, and thus the format needs a constant upgrading for software plug-ins. At the present time there is no unified way to legally exchange music data between devices or final users.

### Solutions are Separate for Low and High Quality Music

One of the biggest problems with existing solutions is that these two worlds of low (inexpensive) and high (expensive) quality music are separate. There does not exist, at present, any commercial solution or any to legally and easily exchange files. One solution is to “upgrade” the portable player by manufacturing better quality devices, or by providing very expensive outboard converters.

This type of solution is not very effective, because the portable players use only compressed data, like MP3, AAC and other formats. Therefore over 90% of the music data is lost using these formats. Portable players also have a small display and very small buttons. Many people find these difficult and uncomfortable to see and use respectively.

Moving in the opposite direction, downloading music from a music server to a portable player has not been considered seriously, because the servers are expensive. True music lovers, a potential group of customers who can be served by the music server, will require higher standards of listening for sound than will their children and many adults, who will continue to be the users of inexpensive devices.

Also, music servers use high quality audio files. It is difficult to direct copy high quality, big size files to limited memory size of portable devices. These files must be converted into lossy compressed files, suited for portable devices.

### A Navigation/Organization Problem

The existing digital media devices do store songs, pictures, video clips, lyrics. Unfortunately, there is not a common multimedia file organization system between different devices. Since computers, portable players, car players, TV sets, mobile phones has many different user interfaces. It is always necessary to learn about the organization and operation of each device from the beginning.

If there are stored hundreds of multimedia data files on these same devices, the navigation problems increase.

At present there does not exist a simple, universal organizer of all different and related multimedia (audio, video, pictures, and text) with a specific relations between them.

The term “related multimedia” means planned connection between them. An example of “related multimedia” could be music, photo of music performer, music composer's biography, lyrics, live concert video. A good example of worldwide and simple organizing standard is the international telephone number system. Despite of different connections (wire, fiber optics, and satellite radio, analog or digital) operation of telephone remains these same for any user.

### A Compatibility Problem—Lack of Standards

Due to many types of data format coding, a universal standard of all multimedia files (audio, video, picture, text) able to replay on any kind of device does not exist. Data files, able to play on one device, cannot be played on another. For example, a video file type, able to replay on computer, may not be replayed on mobile phone, car navigation or TV set if that device has a different data format coding.

The compatibility problems are partially solved by installing several decoders inside player. This way is complicated, costly (most popular decoders needs license fees) and limited. For example, mobile phones manufacturers supply only 2-3 decoders. FIG. 2 is an audio data flow diagram of a conventional memory audio player 30 using compressed data. As is seen, the audio player 30 includes a rewritable memory 34 that accepts audio files 32a-32n of different types. Within the audio player 30 are a plurality of decoders 36a-36n that receive the data from those files via the memory 34. The resultant files are then provided to a digital to analog converter 40 which provides analog signals for the end user.

Another way to solve the compatibility problem is using converting programs for, changing one format of compressed file to another. Unfortunately, compression algorithms (especially lossy) operate as filters in some circumstances. An algorithm may removessome signals that are needed for another format. So, the final sound quality can be very low, with distortion and artifacts.

An exception is Adobe PDF® media standard. Each *.pdf file can be read on any kind of device. These same file can be read on any computer, mobile phone, digital frame, TV set with installed Adobe Acrobat Reader®. The “PDF compatible” reading devices has totally different internal build and programming philosophy, but these same user functions and operation way. “Electronic paper” stored in PDF format is the best example of worldwide media standard. Unfortunately, PDF can display only text and pictures.

### A Copy Protection Problem

Existing methods of commercial multimedia distribution has copy protection systems of limited effectiveness.

The distribution of multimedia files as pure files by downloading (with no media) is exceptionally uncontrolled. Over 95% of MP3 audio files are illegally copied.

Piracy is also a problem when distributing multimedia by physical media, as CD (audio) or DVD (movies). It is easy to make an illegal copy of a CD or DVD which decreases rapidly the legal worldwide sale of the music.

Some pure software solutions of copy protection (like DRM—Digital Rights Management) are unsafe or difficult to implement for wide commercial use.

### A New Way for Commercial Distribution of Multimedia is Necessary

Accordingly, what is needed is a system and method that addresses the above-identified issues. The system and method should be cost effective, easy to implement and compatible with existing systems. The present invention addresses such a need.

### SUMMARY OF THE INVENTION

A method and system is disclosed for distributing multimedia information. The system and method comprises sending a plurality of multimedia files to at least one server; and recording the plurality of multimedia files on a removable memory device. The removable memory device has a format that includes a predetermined information set that is described and physically stored thereon.

The method and system is a complete solution for the commercial multimedia (audio, video, picture, text) distribution. Also, the method and system can be used for commercial distribution of any kind of digital data (programs, bank data, documents, control etc). The method and system uses individual unique keycode for customized access to internet and any other electronic devices. All multimedia data files are stored on a removable memory device as a physical, hardware device.

Accordingly, instead of exchanging the data associated with multimedia information from one media or device to another, the media itself is transferred from one player to another. The media is integrated, easy to use, and is possible to apply both to the low quality as well as the high quality environment.

### BRIEF DESCRIPTION OF THE DRAWINGS

FIG. 1 illustrates the use of CDs at the present time, as the most popular way of commercial distribution of music and software.

FIG. 2 is an audio data flow diagram of a conventional memory audio player 30 using compressed data.

FIG. 3 illustrates use removable memory card with a specified data organization to allow for the commercial distribution multimedia/software/commercial digital data files.

FIG. 4 illustrates an example of a Removable Memory Device in accordance with an embodiment.

FIG. 5 is an audio data flow diagram of a memory audio player 200 using uncompressed data.

FIG. 6 is an example of data files organization for a complex multimedia albums organization.

FIG. 7 shows an example of very simple album structure, with guide “How to repair your bicycle”.

FIGS. 8, 9, 10 illustrate a prototype of a high quality, audio Removable Memory Card player, with no video, picture or text play possibilities.

FIG. 11 illustrates a high end compact disk player.

FIG. 12 illustrates individual access using a unique keycode.

FIG. 13 illustrates an example of dedicated access to Internet.

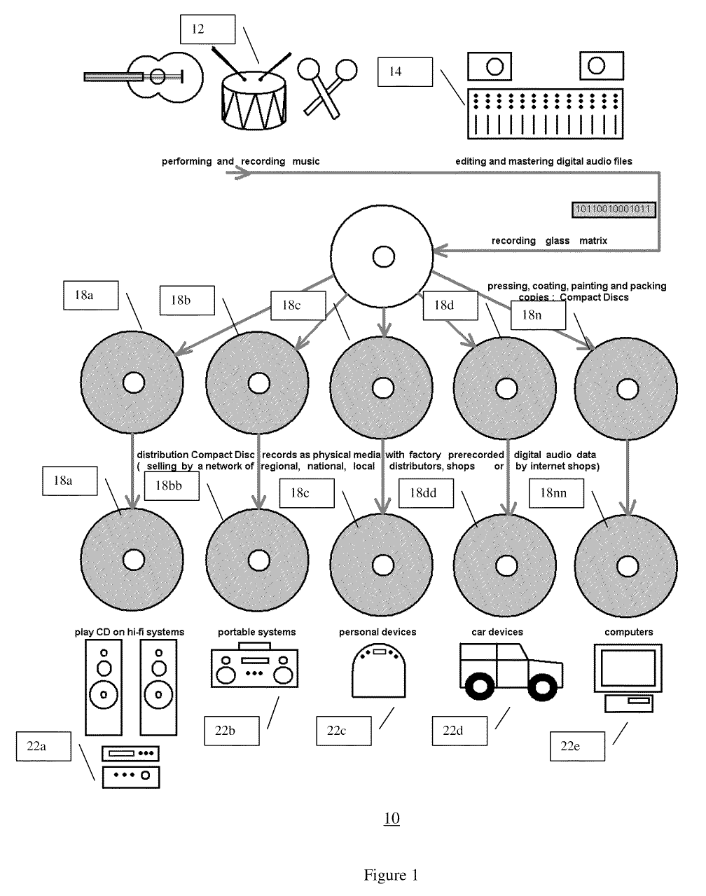

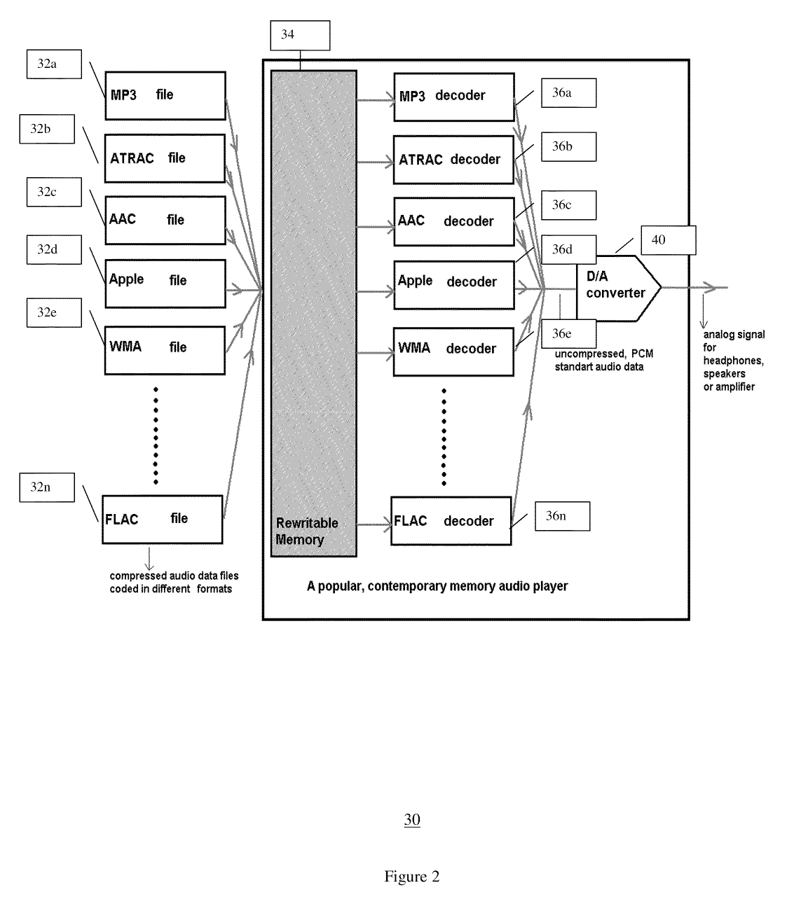

### DETAILED DESCRIPTION

The present invention relates generally to audio and multimedia systems and more particularly to using a memory card for providing high quality non-compressed audio and multimedia data (video, pictures, text) or any other digital files in a variety of environments. The following description is presented to enable one of ordinary skill in the art to make and use the invention and is provided in the context of a patent application and its requirements. Various modifications to the preferred embodiment and the generic principles and features described herein will be readily apparent to those skilled in the art.

The description of the present invention makes numerous references to audio data, because this data is still the most frequently copied, and used of multimedia data. A favorite song is replayed more often, than for example a favorite movie, picture or book. However, one of ordinary skill in the art readily recognizes that the present invention is related any multimedia (video, picture, text) presentation or any other types of digital files.

In the context of the present application, the expression “Removable Memory Device” describes any kind of physical media carrier (like Flash Memory Card, USB Flash Memory, portable hard disc etc.) or any future equivalent solution.

However, due to compact size, reliability, mass production and low price the Removable Flash Memory Cards will be utilized throughout the present application because a Removable Flash Memory Card is type kind of Removable Memory Device.

The Removable Flash Memory Card, with copy controlled security solutions are preferred storage media. Secure Digital (SD), Secure Digital High Capacity (SDHC), Secure Digital Extended Capacity (SDXC), Micro SD and Flash Memory cards are highly recommended.

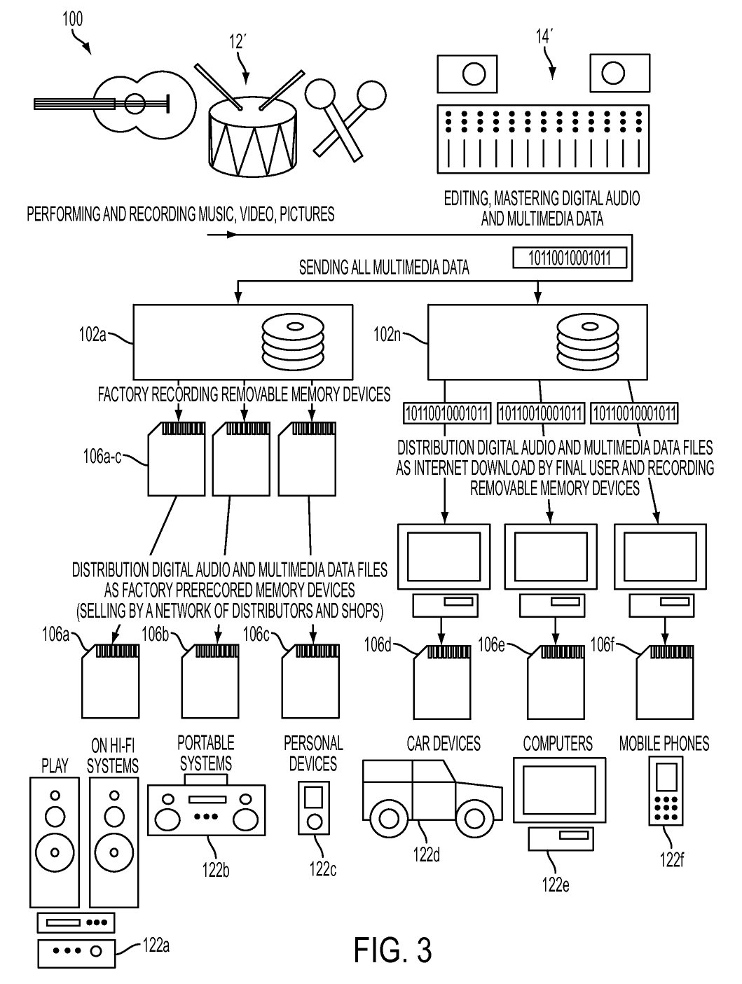

FIG. 3 illustrates a system 100 for the use of one or more Removable Memory Devices with a specified data organization to allow for the commercial distribution multimedia/software/commercial digital data files. As is seen, music is performed and recorded 12′. Thereafter the audio files created by recording the music are edited and mastered 14′. Then the multimedia data is sent to one or more servers 102a and 102b.

There are two ways for copying a multimedia data into Removable Memory Devices 106. The server 102a provides the data to a factory which records the data on a plurality of Removable Memory Devices 106a-106c. These prerecorded Removable Memory Devices devices 106a-106c are then distributed via shops to users of a Hi-Fi system 122a, a portable system 122b and a personal device 122c. Server 102b for example, would distribute the multimedia files as a download over a public network such as the Internet to the computer terminals of the final purchaser of the multimedia data. For example, the Removable Memory Devices 106d-106f can be used for a car device system 22d, a computer 22e and a mobile phone 122f.

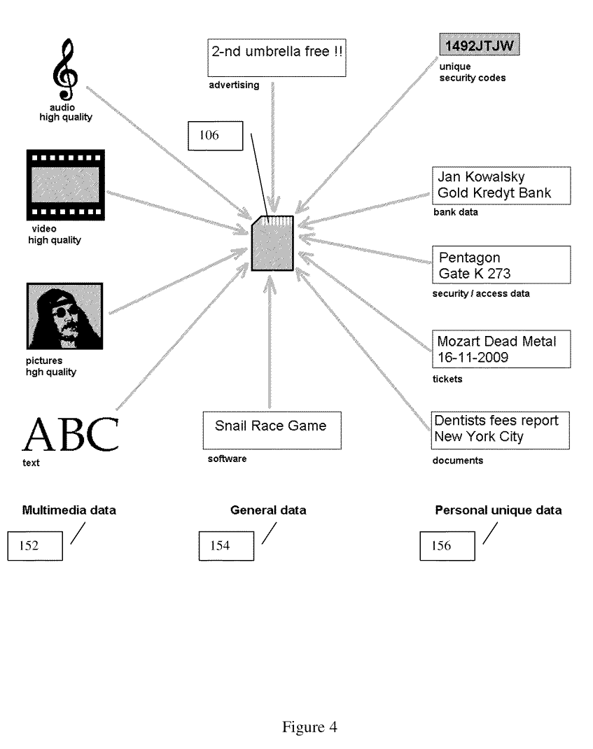

FIG. 4 illustrates an example of a Removable Memory Device in accordance with an embodiment. As can be seen different types of contents such as multimedia data 152, general data 154 and personal unique data 156 can be stored on Removable Memory Device 106 and unique security codes protects illegal access (read, write modify, copy) to the stored data.

To play the same content on different devices, the Removable Memory Device 106 is the media carrier with stored digital data instead of copying files between devices.

This solution allows for the borrowing and/or renting of multimedia and other contents between different users in fully legal way, without risk to illegal copying.

In addition by same final user, using the same media on different devices its operation within those devices will be quick and easy.

### Integration

A large quantity of existing multimedia needs an efficient way to organize them. There exists some solutions, but they are limited to one device group (for example UNIX based computer or iPod® portable player), and there are not fully compatible.

Multimedia and other digital data not only needs organization, but also needs correct relationships. A system and method in accordance with the present invention creates a relationship between audio, video, picture and text. These relationships, like song>song lyrics>song performer photo>song composer biography>live song performance video>interview with composer video are created by multimedia supplier.

Multimedia relationships and organization, as described for example in U.S. application Ser. No. ______ (To be assigned) entitled, Secure Digital Music Album Format, filed on even date herewith, is assigned to the assignee of the present application and is incorporated in its entirety herein, are stored on Removable Memory Device together with multimedia data. The above identified application discloses a multimedia application format and method of use. Instead of exchanging the data associated with multimedia information from one media to another, the media itself is transferred from one player to another. The media is integrated, easy to use, and is possible to apply both to the low quality as well as the high quality audio environment. The format includes but is not limited to music, as well as a booklet, cover, text information, video and photo gallery. The new format does not limit the removable memory card/SD card to only a media carrier but constitutes, rather, a dedicated and controlled interface to Internet contents. At the same time, there is a range of players that are created for personal, portable, car audio, as well as hi-fi and hi-end users.

By changing Removable Memory Device the user not only changes the data therewithin, but also provides the correct organization and relationships between the data.

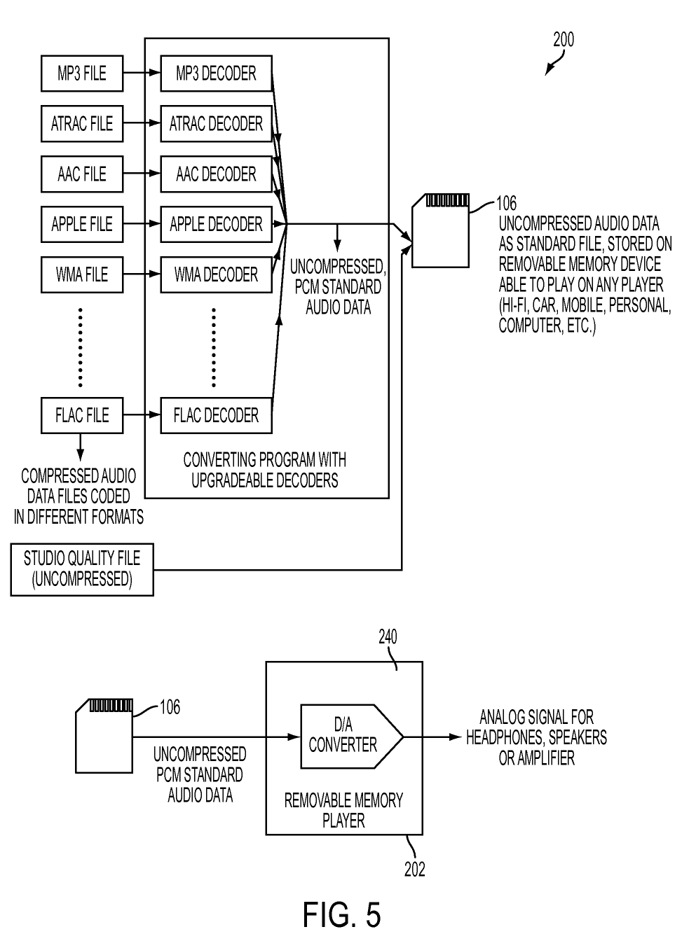

The multimedia data (with relationships and organization) will be prepared by commercial suppliers (like media labels). Even if the data exists in other formats it will be possible to use them on the Removable Memory Device through the use of the conversion programs thereon. To describe these features in more detail refer now to following description in conjunction with the accompanying figures. FIG. 5 is an audio data flow diagram of a memory audio player 200 using uncompressed data. As is seen, the audio player 200 includes a rewritable memory 234 that accepts audio files 232a-232n of different types. Within the audio player 200 are a plurality of decoders 236a-236n that receives the data from those files via the memory 34. The resultant files are then provided to a Removable Memory Device 106 which is able to play on a variety of players. A removable memory player 202 receives uncompressed data and the D/A converter 240 therewithin converts the data to analog signals for the user.

Converting the data on the Removable Memory Device is performed once, and then all multimedia stored on Removable Memory Device 106 will be able to play on any future player which has the same format.

An album is the most popular, successful and clear kind of organizing and relating of existed multimedia.

Each album can include audio tracks, video tracks, pictures related to complete album, pictures related to specified track, text files related to complete album, and text files related to specified track. All of the multimedia data of an album can be stored on one Removable Memory Device for easy and legal exchanging contents between different devices and different users.

Many albums can be stored on one Removable Memory Device for compact collection all needed albums with immediately, random access to each one.

The Removable Memory Device with many albums also can be changed and played on different player devices.

Also, new multimedia contents can be added to existing albums. For example, to archive record of Chopin Sonatas can be added photographs, videos, text. A classic music album consists of music tracks, front-back cover and text booklet can be expanded with a lot of pictures, multi-language texts, video clips.

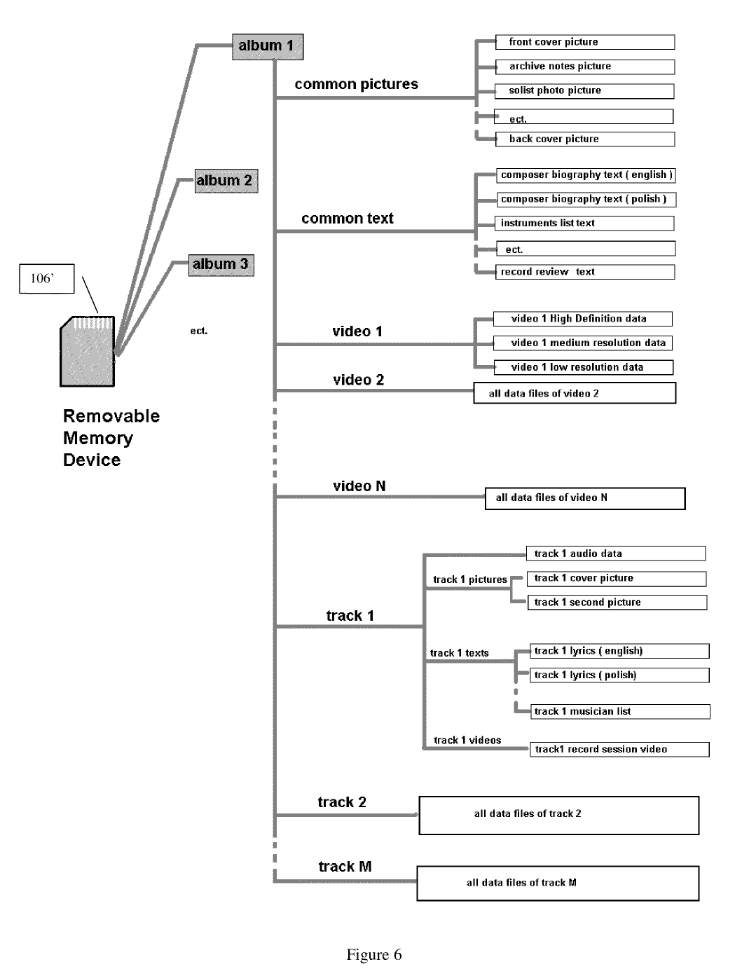

A system and method in accordance with the present invention, will allow for the full integration of all multimedia files and relationships. FIG. 6 is an example of data files organization for a complex multimedia albums organization. In this example an album includes common pictures, common text, a plurality of videos and a plurality of music tracks. There would also be a plurality of other albums that would be organized in the same way on the device 106.

There are many possible kinds of multimedia albums. It includes but is not limited to albums that are music-oriented (like classic CD record with booklet, with reduced video information), movie-oriented albums with reduced audio information) and the like.

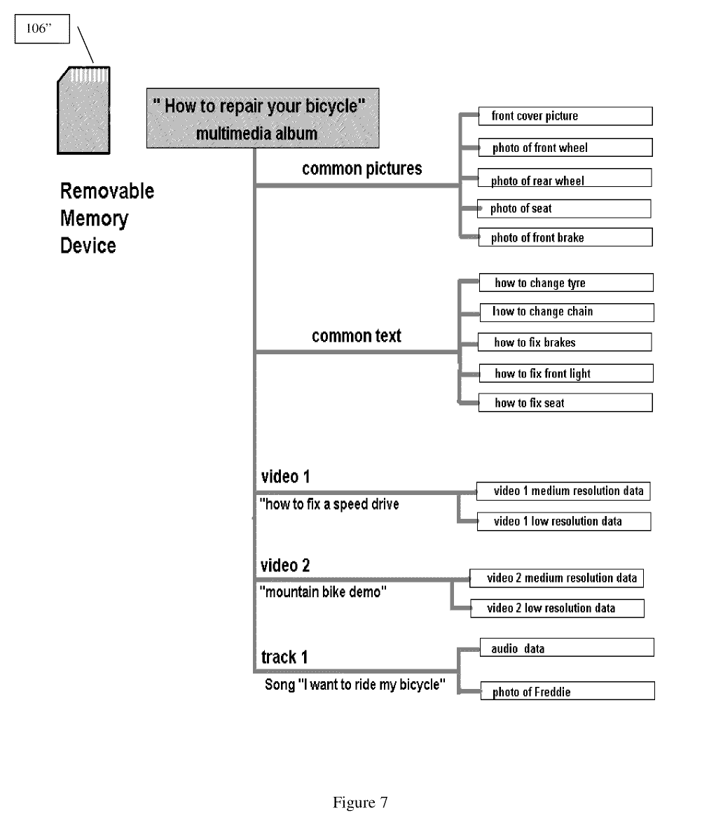

Even simple albums, like catalogs, manual guides and many other are possible. FIG. 7 shows an example of very simple album structure, with guide “How to repair your bicycle”.

Accordingly, a system and method in accordance with the present invention integrates low and high quality solutions. Sound, video or picture quality will depend of player device quality, not of the stored data. A system and method in accordance with the present invention integrates multimedia solutions for high and low quality devices, stationary, portable, car, personal, computer and other.

### Ease of Use

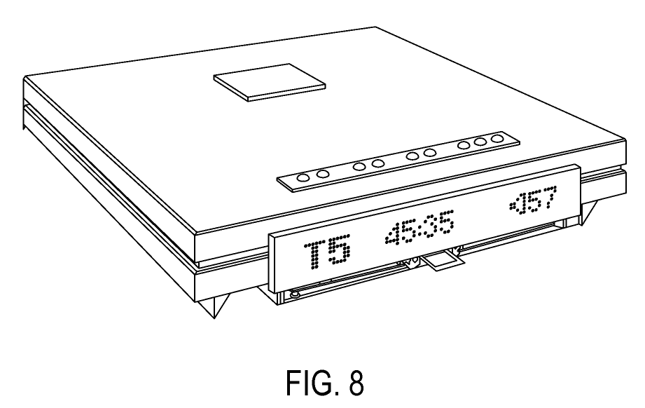

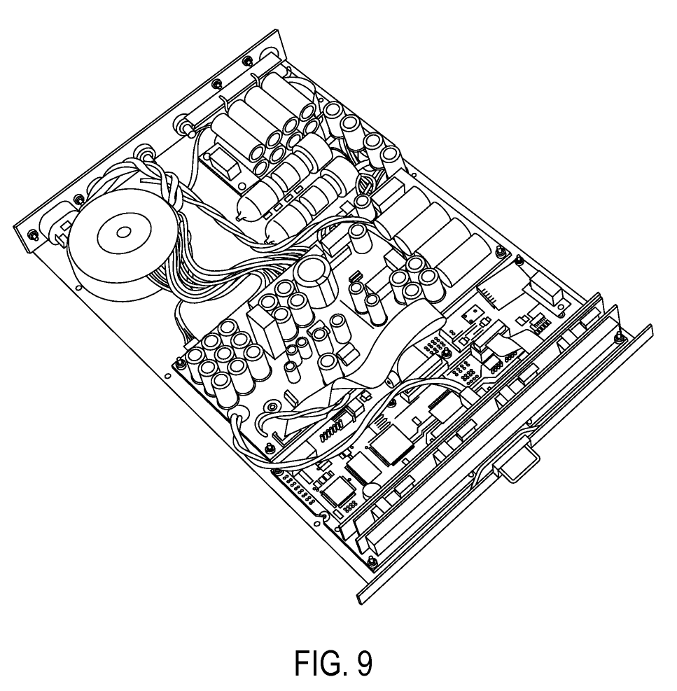

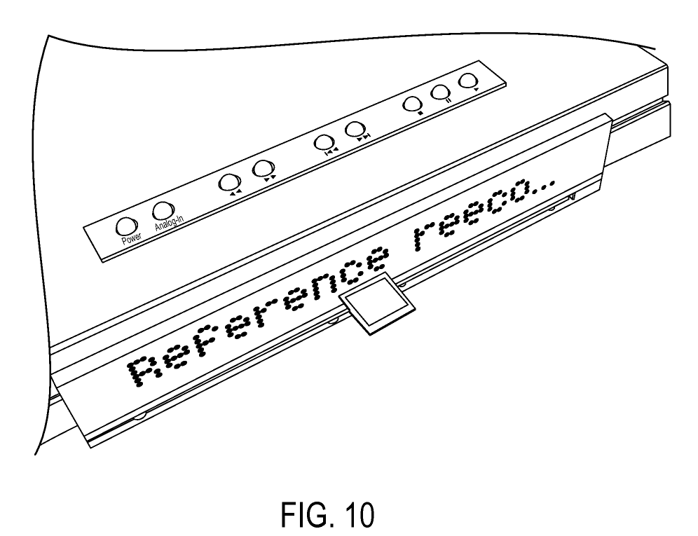

Even if the player device will have a limited functionality (for example no display) it can use these same Removable Memory Device reading only a part of the data from the device. FIGS. 8, 9, 10 illustrate a prototype of a high quality, audio Removable Memory Card player, with no video, picture or text play possibilities.

A system and method in accordance with the present invention allows for the both types of integration of commercial distribution of data: as sale of physical media carrier or as downloaded data as shown in FIG. 3. The same Removable Memory Device with stored multimedia data can be used in all future devices with full compatibility based on the use of the same organizational structure.

The operation (navigation, display, etc) should be as similar as possible for all player devices. Learning the operation of one system utilizing the Removable Memory Device only needs to occur once, the final user will then be able use the Removable Memory Device 106 on any system.

Due to the differences between devices some minor differences of operation ways are acceptable. For example, mobile phones has limited keyboard (or even have no keyboard—but only touchscreen) to compare with computers. Large plasma or LCD TV can be operated only by remote control, not by touchscreen as in portable players.

### Audio

Audio data can be stored as uncompressed, high quality files uses native PCM format with sampling frequencies from 44 kHz to 200 kHz, data word 16 to 32 bit. Two to eight audio channels are expected and compressed files are permitted. Uncompressed audio data not only ensures the highest sound quality, but also they don't need complicated decoding. It is possible to play them even by the simplest players as shown in FIG. 5. A uncompressed audio data file is also the most versatile format. Uncompressed files require more memory than compressed ones, but as the technology rapidly progresses the capacity of Removable Memory Devices also rapidly increases with lower prices.

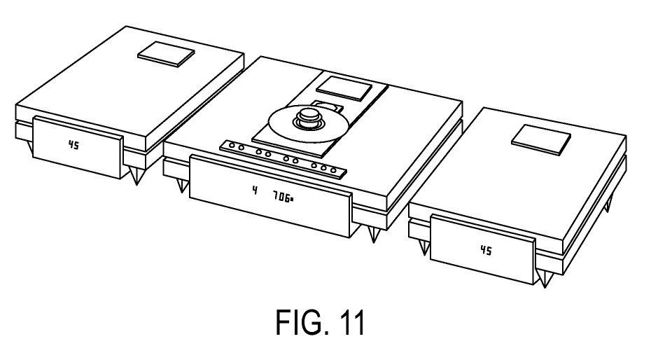

The sound quality of Removable Memory Device player as digital audio source is the highest possible. It has been determined when comparing music that is the same audio data on the a high quality CD player (Ancient Audio Lektor Grand SE) shown for example in FIG. 11 and a prototype Removable Memory Device (Secure Digital Flash Memory Card) audio player, shown in FIGS. 8, 9 and 10. Due to the lack of moving parts, and simple internal architecture the sound quality of prototype Removable Memory player was higher.

### Video

Any coding of video signals is acceptable. Because video signal generates much more data than audio, a lossy compression/coding is necessary. Different resolutions of video signal are also permitted. High quality and high resolution video data files typically require complicated decoders. To use a method and system in accordance with the present invention broadly, the video data can be coded in a plurality of resolutions/qualities. For example the video can be coded into three resolutions/qualities. They will be described below.

High Definition (like 1080×1920 pixels progressive or similar) video data files, will be suited for big plasma/LCD displays.

Medium resolution video data files, like VGA, PAL, NTSC (720×576 pixels or similar) as classic TV or DVD picture quality will be suited for portable computers, medium-size TV sets, and car/portable devices.

Low resolution video data files (like QVGA: 240×320 pixels) will be suited for simple, portable devices (as mobile phones) with limited computing power.

Each High Definition and Medium resolution video data file can be also stored as additional, low resolution video file. This ensures playability albums even on simplest devices.

In a preferred embodiment, a video coding/decoding standard for each resolution/quality degree for absolute compatibility is desirable.

### Picture

It is preferable to store pictures in a high resolution (1024×1024 pixels or higher) format. Any coding system can be used; however JPEG format is the preferred coding system. Even very large pictures (high resolution) can be easily downscaled for the small displays of portable devices.

### Text

Any text data can be stored; however UTF-16 format is preferred. UTF-16 text format needs two bytes for one character, (instead of one byte in case of popular ASCII) but ensures common coding to all languages.

### Other Data

A system and method in accordance with the present invention can be applied also to commercial distribution any digital data, software, programs (like games, utility programs, office programs, industrial control etc.). Also any advertising data (audio, video, picture, text, programs) can be easy added.

A system and method in accordance with the present can be applied to the storing of any personal individual, unique data like bank data, access/security, documents, professional data, PIN (Personal Identification Number) etc.

### Keycode

The Removable Memory Device should have the protected memory area, with no direct access by final user. Each Removable Memory Device) should have a unique Media Identifier number, and other data stored in hidden memory area.

The unique keycode stored on hidden memory area of Removable Memory Device can include Media Identifier unique number and other secret data, generated by multimedia or data provider.

Each Removable Memory Device with stored multimedia or another data files can also store one or more unique keycodes.

The unique keycode can be utilized for copy protection.

Also the unique keycode can be use for dedicated, individual access for any future multimedia, data, tickets etc, by Internet or any digital networks or devices.

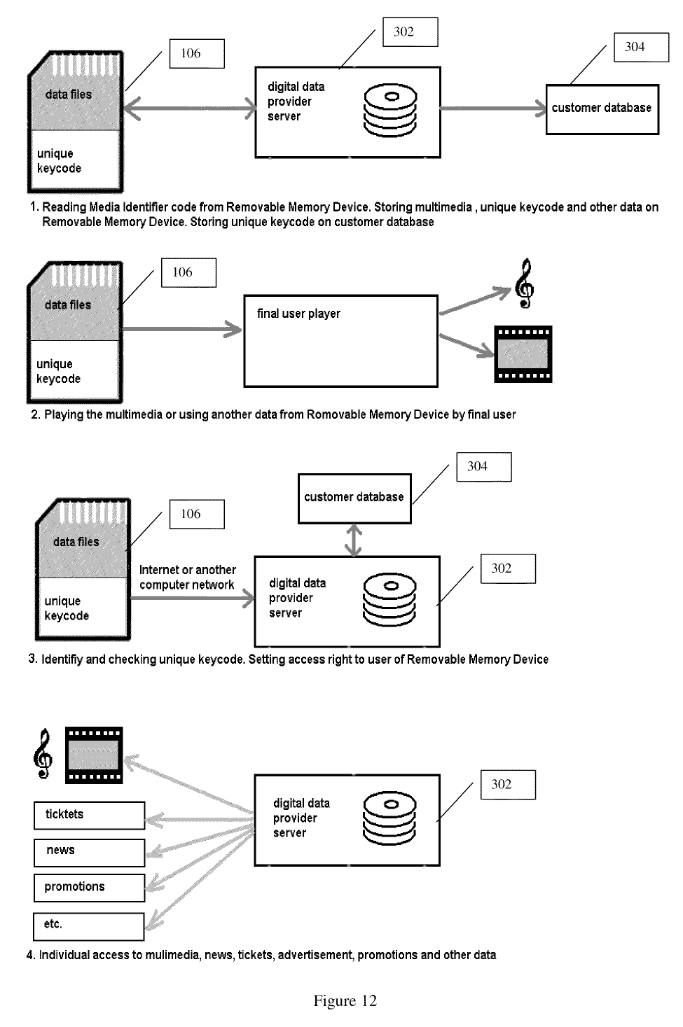

FIG. 12 illustrates individual access using a unique keycode. First, the unique Media Identifier number is read from Removable Memory Device 106 by digital data provider server 302.

Then, the unique keycode is calculated and stored in a hidden area of Removable Memory Device 106. Also, the unique keycode is stored in customer database 304 of digital data provider.

As the next step, multimedia and other data contents is written into the Removable Memory Device 106. The Removable Memory Device 106 is ready, for example for play by final user player 304.

Later, the unique keycode form Removable Memory Device 106 is read by digital data provider server 302 as media/content identification that can used for personalized, individual access for any future data, news, promotion, tickets etc.

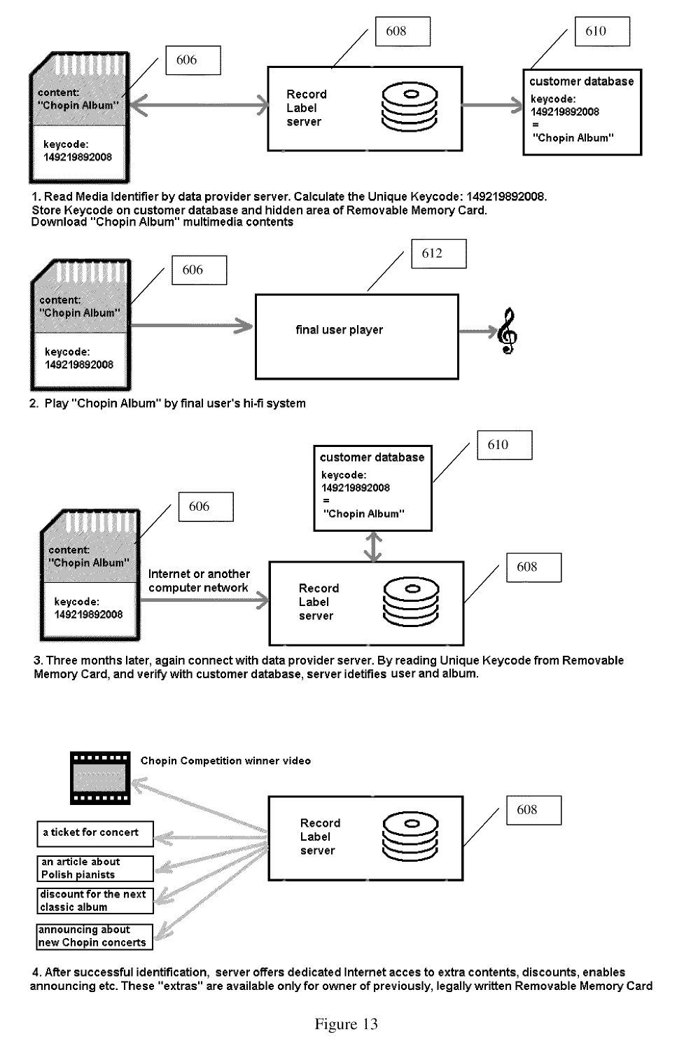

FIG. 13 illustrates an example of dedicated access to Internet utilizing the Removable Memory Device 606. The multimedia contents of “Chopin Album” are stored on Removable Memory Device 606, with the unique keycode by legally downloading data from Record Label server 608. The keycode is also stored in Record Label customer database 610. The Removable Memory Device 606 with “Chopin Album” is played by final user home hi-fi system 612.

Three months later, a final user again connects to Record Label server 608 applying Removable Memory Device 606 with stored “Chopin Album”. The A unique keycode is sent to a record label server 608. The server 608 verifies the unique keycode with the customer database.

As a bonus for the owner of legally copying card, the server enables access to “Chopin Competition winner” video, an article about Polish pianists, and discount for the next classical music album, free tickets for Chopin concert in Warszawa, and announces the most attractive Chopin concerts worldwide.

An access to extra data and offers, described above will be possible only for owners of previously, legally downloaded cards. It will work as additional copy protection—owners of illegally copied cards without correct unique keycode will have no additional, individual access to extra values.

Also, the unique keycode will enable the described invention as open system. Due to easy identification of the Removable Memory Device and its stored data it will be possible to add new or extra related data, or modify old. For data/copyright security, Copy Protection Right Management (CPRM) system or another copy/access control system can be applied for any Removable Memory Device.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for the distribution of multimedia information comprising:
sending a plurality of multimedia files to at least one server; and
recording the plurality of multimedia files on a removable memory device, the removable memory device having a format that includes a predetermined information set that is described and physically stored thereon.

2. The method of claim 1 wherein the recording step comprises factory recording the plurality of multimedia files on the removable memory device.

3. The method of claim 1 wherein the recording step comprises downloading the plurality of multimedia files via public network to at least one computer system and recording the plurality of multimedia files on the removable memory device.

4. The method of claim 1 wherein the removable memory device comprises any of an SD card, any Flash memory card, and any USB Flash memory device.

5. The method of claim 1 wherein the predetermined information set comprises a plurality of albums, wherein a predetermined number of albums are supported on the removable memory device.

6. The method of claim 5 wherein the album includes audio tracks, album pictures, album text and album videos wherein a predetermined number of each of the audio. tracks, album pictures, album text and album videos are supported on the removable memory device.

7. The method of claim 6 can use uncompressed audio files.

8. The method of claim 6 can use high resolution picture files.

9. The method of claim 6 wherein the video contents can be apply as low resolution, medium resolution and High Definition TV video files that contain the same or different material.

10. The method of claim 1 wherein the removable memory device includes a unique keycode which identifies the owner of the removable memory device and sets access rights of the user of the device.

11. The method of claim 10 wherein the at least one server comprises a digital data provider server which reads the unique keycode from the removable memory device, and stores the multimedia content on the removable memory device based on the access rights of the user.

12. The method of claim 10 wherein the unique keycode of the removable memory device allows for dedicated access via the Internet and other computing devices.

13. A system for the distribution of multimedia information comprising:
means for sending a plurality of multimedia files to at least one server; and
means for recording the plurality of multimedia files on a removable memory device, the removable memory device having a format that includes a predetermined information set that is described and physically stored thereon.

14. The system of claim 13 wherein the recording means comprises factory recording the plurality of multimedia files on the removable memory device.

15. The system of claim 13 wherein the recording means comprises downloading the plurality of multimedia files via public network to at least one computer system and recording the plurality of multimedia files on the removable memory device.

16. The system of claim 13 wherein the removable memory device comprises any of an SD card, any Flash memory card, and any USB Flash memory device.

17. The system of claim 13 wherein the predetermined information set comprises a plurality of albums, wherein a predetermined number of albums are supported on the removable memory device.

18. The system of claim 17 wherein the album includes audio tracks, album pictures, album text and album videos wherein a predetermined number of each of the audio. tracks, album pictures, album text and album videos are supported on the removable memory device.

19. The system of claim 13 wherein the removable memory device includes a unique keycode which identifies the owner of the removable memory device and sets access rights of the user of the device.

20. The system of claim 19 wherein the at least one server comprises a digital data provider server which reads the unique keycode from the removable memory device, and stores the multimedia content on the removable memory device based on the access rights of the user.

21. The system of claim 19 wherein the unique keycode of the removable memory device allows for dedicated access via the Internet and other computing device.

22. A removable memory device comprising;
a plurality of data files; the plurality of data files being stored as at least one high quality multimedia album; the removable memory device having a format that includes a predetermined information set that is described and physically stored thereon for organizing the contents of the album.

23. The removable memory device of claim 22 wherein the removable memory device comprises any of an SD card,any Flash memory card, and any USB Flash memory device.

24. The removable memory device of claim 22 wherein the predetermined information set comprises a plurality of albums, wherein a predetermined number of albums are supported on the removable memory device.

25. The removable memory device of claim 24 wherein the album includes audio tracks, album pictures, album text and album videos wherein a predetermined number of each of the audio. tracks, album pictures, album text and album videos are supported on the removable memory device.

26. The removable memory device of claim 22 which includes a unique keycode which identifies the owner of the removable memory device and sets access rights of the user of the device.

27. The removable memory device of claim 26 wherein the unique keycode of the removable memory device allows for dedicated access via the Internet and other computing device.
